(19) United States
(12) Patent Application Publication
(10) Pub. No.: US 2005/0200487 A1
(43) Pub. Date: Sep. 15, 2005

(54) Methods and devices for monitoring the distance between members of a group

(76) Inventors: Ryan O'Donnell, Guilderland, NY (US); John Joseph Blackburn, Squamish, CA (US); Keith A. Lareau, Granby, CT (US)

Correspondence Address: HESLIN ROTHENBERG FARLEY & MESITI PC, 5 COLUMBIA CIRCLE, ALBANY, NY, 12203, US

(21) Appl. No.: 11/072,146

(22) Filed: Mar. 4, 2005

Related U.S. Application Data
(60) Provisional application No. 60/550,768, filed on Mar. 6, 2004.

(51) Int. Cl. G08B 23/00

(52) U.S. Cl. 340/573.1

(57) ABSTRACT

Emergency workers and other personnel are often endangered by losing contact with other personnel, for example, firefighters working in hostile conditions. Methods and devices for improving the survivability and reducing the potential for injury or death of emergency personnel and others are provided. The methods and devices monitor the distance of members of a group to, among other things, minimize or prevent personnel from being separated from the group. Devices worn by members of a group monitor the distance between members by monitoring the characteristics of wireless communication, for example, signal strength, between members. If the distance between members exceeds or is less than a predetermined distance, an alarm is sounded to alert members to the potential for contact between members or loss of a member of the group. Though aspects of the invention may be used by emergency workers, such as firefighters and policemen, other aspects of the invention may be used to monitor objects or children, among others.

### CROSS-REFERENCE TO RELATED APPLICATIONS

This application claims priority from pending provisional application 60/550,768 filed on Mar. 6, 2004, the disclosure of which is hereby incorporated by reference herein in its entirety.

### TECHNICAL FIELD

This invention relates to methods and devices for monitoring the proximity of members of a group to prevent dissociation of a member from the group. More particularly, this invention relates to wireless methods and devices for monitoring the distance of members of a group, for example, firefighters or hazardous environment workers, to enhance the survivability of the members.

### BACKGROUND INFORMATION

Various types of wireless proximity detectors have been known in the art for tracking members of a group. For example, U.S. Pat. No. 5,748,087 describes a “Remote personal security alarm system” which monitors the proximity of a child or a patient wearing a transmitter in relation to a handheld device. This system alarms when the child or patient moves beyond a present distance from the handheld device. However, these devices are not easily expandable or independent. These prior art devices and their use are typical of master/slave systems which work well in limited, controlled situations.

U.S. Pat. No. 6,600,418 describes an object tracking and management system and a method using radio-frequency identification (RFID) which monitors groups of objects with attached RFID tags. The system disclosed in this patent uses an interrogator to receive and decode the identity of several tags. These systems and methods, again, are typically not easily expandable or independent, nor do these systems allow group members to form their own independent groups or networks.

U.S. Pat. No. 6,611,556 discloses a wireless technology for tracking the presence and/or absence of members of a defined group. The system disclosed in this patent utilizes a single transmitter/receiver with several transmitters to monitor presence and/or absence of members of the group. However, the disclosed system does not allow the members of the group to form their own groups or networks with their own rules defining presence and/or absence of members.

Aspects of the present invention overcome these disadvantages of the prior art while providing improved methods and devices for monitoring members of a group to minimize or prevent dissociation of members while allowing members to form separate independent groups.

### SUMMARY OF THE INVENTION

Aspects of the present invention provide a wireless system by which individual units, for example, individual humans, in proximity can maintain a group or network. Aspects of the invention allow individual units to track other members of a group or network and alert network members when a network member exits the network. For example, in one aspect, the invention provides wireless communications between individual units which include, for instance, unit identifiers and other network information. One version of the system is composed of at least two modules, each module may include a transmitter, a receiver, a microcontroller, and a user interface. Two or more modules may form a network, which monitors its own group members. Any group member may leave its network and become a member of another network or new members may be introduce to a network from another network or from outside the system. The addition of a radio frequency identification tag to this system is possible to track unit ID's for other applications.

One aspect of the invention are methods, systems, and devices for determining the relative proximity of members of a group, for example, using methods of determining relative member proximity, for example, known methods of determining relative member proximity, and then advising at least one member of the group when the relative proximity of at least one member of the group deviates from a desired proximity, that is, either too far or too close. This advising or warning may be effected by means of, for example, an audible or visual alarm. In one aspect, the group may include at least 2 members, or at least 3 members.

Another aspect of the invention is a method for monitoring a distance between members of a group, the method comprising: providing each of the members with a monitor, the monitor adapted to determine the relative position of each monitor and the other monitors; determining the distance between the monitors; comparing the distance to the distance to the predetermined distance; and activating a signal when the distance between at least two monitors deviates from the predetermined distance. In one aspect, the predetermined distance comprises a maximum distance or a minimum distance. In one aspect of the invention, determining the distance between monitors is practiced using methods comprising electromagnetic signal characteristic detection, accelerometers, or radio wave positioning, among other methods.

Another aspect of the invention is a device for monitoring the distance between members of a group, the device comprising: means for determining the distance from the device to another similar device; and means for activating a signal when the distance between the devices deviates from a predetermined distance. In one aspect, the predetermined distance comprises a maximum distance or a minimum distance. In one aspect of the invention, the means for determining the distance from the device from another similar device comprises electromagnetic signal characteristic detection, accelerometers, or radio wave positioning, among other methods.

Another aspect of the invention is a method for monitoring the distance of between members of a group, the group having a plurality of members, the method including providing each of the plurality of members with a monitor, the monitor adapted to transmit at least one signal, to receive at least one signal transmitted from at least one other monitor, and to determine a characteristic of the at least one received signal representative of the distance of the monitor from the at least one other monitor within the group; transmitting at least one first signal from a first monitor provided to a first member of the group; receiving the at least one first signal by a second monitor provided to a second member of the group; determining the characteristic of the at least one received first signal representative of the distance between the first monitor and the second monitor; comparing the characteristic of the at least one received first signal to a predetermined characteristic; and when the determined characteristic deviates from the predetermined characteristic, activating a signal advising at least one member of the deviation. In one aspect of this method new members may be introduced to the group. In another aspect of the invention, subgroups may be formed from the group. In one aspect of the invention, the characteristic of the signal may be signal strength, the difference in time of arrival of two signals, the phasing of the wave, the signal wave shape, or the content of the signal, for example, the relative position of the signal source.

Another aspect of the invention is a device for use in monitoring the distance between members of a group, the group having a plurality of members, the device including a transmitter adapted to transmit at least one signal; a receiver adapted to receive at least one signal transmitted from at least one other device; means for determining a characteristic of the at least one received signal representative of the distance to the at least one other device; means for comparing the characteristic of the at least one received signal to a predetermined characteristic; and means for activating a signal when the determined characteristic deviates from the predetermined characteristic. In one aspect, the predetermined characteristic may be a function of one or more environmental conditions, for example, visibility. In one aspect of the device, the device is adapted to transmit and receive a radio frequency signal and an ultrasonic signal.

A further aspect of the invention is a method for improving the survivability of emergency workers working as a group in proximity to each other, for example, firefighters, policemen, rescue workers, medical technicians, SCUBA divers, and the like, or any individual operating in a hazardous or low visibility environment. The method includes providing each emergency worker with a monitor, the monitor adapted to transmit at least one signal, to receive at least one signal transmitted from at least one other monitor, and to determine a characteristic of the at least one received signal representative of the distance of the monitor from the at least one other monitor within the group; transmitting at least one first signal from a first monitor provided to a first emergency worker; receiving the at least one first signal by a second monitor provided to a second emergency worker; determining the characteristic of the at least one received first signal representative of the distance between the first monitor and the second monitor; comparing the characteristic of the at least one received first signal to a predetermined characteristic; and when the determined characteristic deviates from the predetermined characteristic, activating a signal advising at least one emergency worker in the group of the deviation. In one aspect of the invention, activating a signal comprises activating one of an audible alarm signal, a visual alarm signal, a palpable alarm signal, or any alarm signal that may be transmitted by means of electromagnetic ration, for example, infrared (IR) or radio.

A further aspect of the invention is a method for monitoring the distance between members of a group, the method including providing at least two members with a monitor, the monitor adapted to determine the position of the monitor, adapted to transmit at least one signal containing information related to the position of the monitor, and adapted to receive at least one signal transmitted from at least one other monitor; determining the position of the first monitor; transmitting at least one first signal from a first monitor provided to a first member of the group, the first signal containing information related to the position of the first monitor; receiving the at least one first signal containing information related to the position of the first monitor by a second monitor provided to a second member of the group; determining the position of the second monitor; comparing the position of the first monitor to the position of the second monitor to determine a distance between the first monitor and the second monitor; comparing the distance to a predetermined distance; and when the distance deviates from the predetermined distance, activating a signal advising at least one member of the deviation. In one aspect, determining the position of the first monitor is practiced using an accelerometer or a global positioning system, among other means.

Another aspect of the invention is a device for monitoring the distance between members of a group, the device including means for determining the position of the device; a transmitter adapted to transmit at least one signal, the at least one signal containing information related to the position of the device; a receiver adapted to receive at least one signal transmitted from at least one other device, the received signal containing information related to the position of the other device; means for comparing the position of the device to the position of the other device to determining a distance between the device and the other device; means for comparing the distance to a predetermined distance; and means for activating a signal when the distance deviates from the predetermined distance.

These and other aspects, features, and advantages of this invention will become apparent from the following detailed description of the various aspects of the invention taken in conjunction with the accompanying drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention will be readily understood from the following detailed description of aspects of the invention taken in conjunction with the accompanying drawings in which:

FIG. 1 is a schematic of a group having two members each member having a monitor according to one aspect of the invention.

FIG. 2 is a schematic diagram of members of a group, each member having a monitor, according to another aspect of the invention.

FIG. 3 is a schematic diagram of members of a group from which two groups may be formed according to an aspect of the invention.

FIG. 4 is a schematic diagram of members of a group and a member outside the group according to an aspect of the invention.

FIG. 5 is a perspective view of a monitor according to an aspect of the invention.

FIG. 6 is an exploded perspective view of the monitor shown in FIG. 5.

FIG. 7 is a perspective view of a visibility sensor according to one aspect of the invention.

FIG. 8 is a side elevation view of the visibility sensor shown in FIG. 7.

FIG. 9 is perspective view of a monitor according to another aspect of the invention.

FIG. 10 is a left side elevation view of the monitor shown in FIG. 9.

FIG. 11 is a front elevation view of the monitor shown in FIG. 9.

FIG. 12 is a top plan view of the monitor shown in FIG. 9.

FIG. 13 is perspective view of another monitor according to another aspect of the invention.

FIG. 14 is a left side elevation view of the monitor shown in FIG. 13.

FIG. 15 is a front elevation view of the monitor shown in FIG. 13.

FIG. 16 is a top plan view of the monitor shown in FIG. 13.

FIG. 17 is a block diagram of the functions of one aspect of the present invention.

FIG. 18 is a block diagram of the functions of another aspect of the invention.

FIG. 19 is a perspective view of a monitor system having two components according to another aspect of the invention.

FIG. 20 is an exploded perspective view of the two-component system shown in FIG. 19.

### DETAILED DESCRIPTION OF THE INVENTION

In one aspect, the invention provides a method and a system, for example, a wireless system, by which individual members in a group or network of members may maintain the spatial integrity of the group or network. For example, in one aspect, a method or system is provided which allows individual members of a group or network to monitor or track other members of the group or network and alert members when at least one member intentionally or unintentional exits the space of the group or network. In one aspect, monitoring of the members of a group is provided by wireless communications between individual members and the other members of the group.

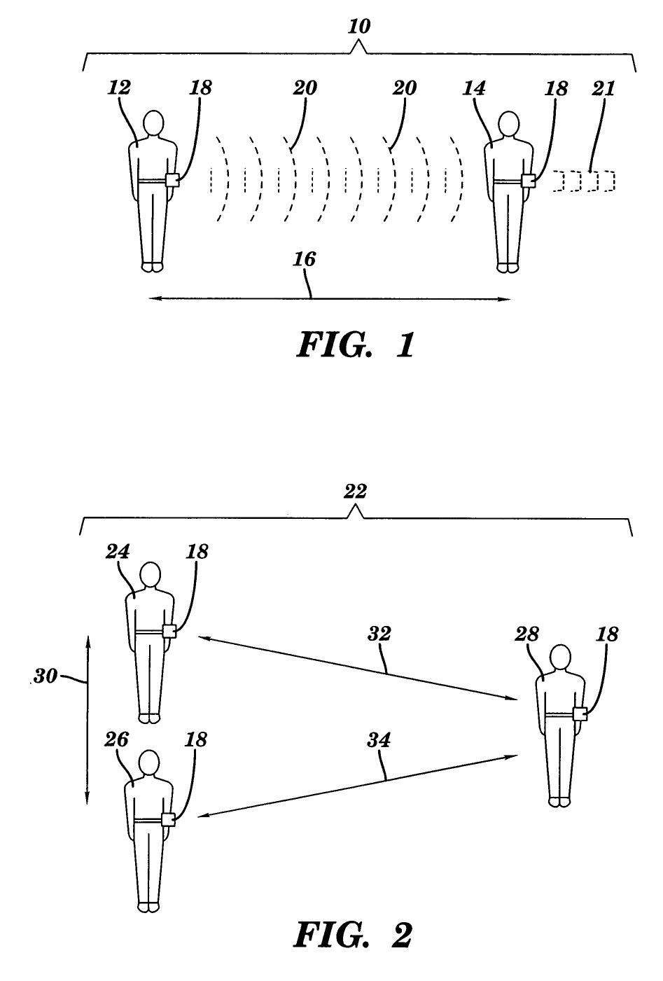

FIG. 1 is a schematic of a group or network 10 having two members 12 and 14 according to one aspect of the invention. According to the present invention, members 12 and 14 may be separated by a distance of separation 16. Members 12 and 14 may comprise any individuals, animals, items, articles, and the like, for which it is desirable to limit the distance of separation 16. For example, in one aspect, members 12 and 14 may be firefighters, policemen, emergency personnel, or hazardous waste handlers, among others. In another aspect of the invention, members 12 and 14 may be any two individuals, including husband and wife, parent and child, grandparent and grandchild, among others. In another aspect of the invention, member 12 may be human and member 14 may be an animal or inanimate object, such as a purse, a piece of luggage, a laptop computer, or an automobile, and the like. In another aspect, members 12 and 14 may also be non-human objects for which the distance 16 between may require monitoring. For example, members 12 and 14 may comprise containers having substances, for instance, chemicals, which when located in too close proximity to each other pose a potential undesirable or hazardous reaction. Those of skill in the art will recognize the many other humans, animals, or inanimate objects may be represented by members 12 and 14, and any other members referenced herein.

According to one aspect of the invention, members 12 and 14 each have a monitor 18, for example, mounted somewhere to members 12 and 14. For example, when members 12 and 14 are human, monitors 18 may be mounted to a belt or harness, or otherwise attached to or embedded in the clothing worn by members 12 and 14. For instance, monitor 18 may be embedded in a helmet, a vest, a backpack, or in a firefighters coat or “turn out” gear. In the aspect of the invention where member 12 or 14 is an animal, monitor 18 may be mounted to a collar. According to this aspect of the invention, monitor 18 may be adapted to transmit at least one signal and receive at least one signal, for example, monitor 18 may be a transmitter and receiver, or a transceiver. The transmission of a signal is represented in FIG. 1 by signal 20 by illustrated phantom lines. Signal 20 may comprise any form of wireless signal, for example, an electromagnetic signal, for instance, a microwave, a radio, a visible light, or terahertz signal, among others, or a sonic signal, for example, an ultrasonic signal. In one aspect of the invention, monitors 18 may be adapted to detect a characteristic of signal 20, for example, detect a characteristic of signal 20 that can be used to characterize the distance 16.

In one aspect of the invention, the characteristic that may be detected by monitor 18 may comprise an information carried by a signal that can be interpreted as an indication of distance between devices, for example, signal strength, differences in time of arrival (TOA), signal phase, signal waveform (or any other signal wave property), or information encoded in the signal, for instance, monitor position, among other ranging techniques. For example, in one aspect, monitor 18 may include a processor adapted to detect an electromagnetic signal, for example, an RF signal, and compare the strength, or amplitude, of the signal to a predetermined signal strength and when the detected signal strength deviates from the predetermined signal strength, for example, is lower than the predetermined signal strength, the processor directs a signal to activate. In another aspect, monitor 18 may include a receiver adapted to detect a plurality of signals, for example, an electromagnetic signal and a sonic signal, and compare one or more characteristics of the plurality of signals to a predetermined threshold. In one aspect, two signals, for example, an RF signal and an ultrasonic signal may be emitted at substantially the same time from a first monitor 18 and may be detected by a second monitor 18. A processor in the second monitor 18 may be adapted to measure the difference in the time of arrival (TOA) of the two signals and from this determine the relative separation 16 of the first monitor 18 from the second monitor 18. Again, in one aspect, this difference may be compared to a threshold value and a signal emitted, for example, an alarm signal, when a deviation from the threshold value is detected. This TOA method may be similar to the method described by Savvides, et al. “Dynamic fine-grained localization in ad-hoc networks of sensors” Proceedings of the Seventh Annual ACM/IEEE International Conference on Mobile Computing and Networking (MobilCom 2001), Rome, Italy, July 2001, the disclosure of which is incorporated by reference herein.

In another aspect, of the invention, monitors 18 may be adapted to detected the shape or phase (that is, phase angle) of signal 20 and from this information obtain an estimate of the distance 16. For example, in one aspect, monitors 18 may contain sensors adapted to detect the slope or curvature of the electromagnetic wave of signal 20 and from this slope or curvature determine at least an approximate distance 16. In one aspect of the invention, signal 20 may include at least two electromagnetic signals from which the shape or phase signal 20 can be detected.

According to one aspect of the present invention, monitor 18 may be adapted to emit a signal 21 when monitor 18 detects a characteristic of signal 20 that indicates that a predetermined distance of separation 16 has been exceeded. This signal 21 may be an audible signal, such as an alarm, and/or a visual signal, such as a flashing light, and/or an inaudible signal, such as a radio signal, among other signals. In one aspect, signal 21 may comprise an infrared (IR) signal or beacon detectable by an sensing device, for example, an infrared camera or a thermal imaging camera or a related device.

In one aspect of the invention, monitors 18 may include means for determining the relative position of monitors 18, and thus the position of members 12 and 14. For example, by means of a positioning sensor, for example, an accelerometer or a sensor adapted to receive and decode one or more signals from a positioning system, for example, a global positioning system (GPS) or a local “in-door GPS system,” and the like. In one aspect, the accelerometer may be very accurate 3-dimensional accelerometer, for example, an accelerometer provided by Analog Devices, or its equivalent. In this aspect of the invention, signal 21 may contain at least some information related to the position determined by the means for determining position.

In one aspect of the invention, monitors 18 may be adapted to include a particle emitter and/or a particle detector which may be used to determine relative distance 16 between members 12, and 14. In one aspect, the particles emitted by monitor 18 on member 12 may be detected by monitor 18 on member 14. In one aspect of the invention, the relative distance 16 between member 12 and 14 may be estimated by the relative number of particles detected, that is, the particle count, over a given period of time. The particle emitter and detector may comprise any type of devices adapted to emit and detect a broad range of particles and associated radiation, for example, radioactive particles, such as, alpha particles, beta particles, or gamma rays; electrically-charged particles, such as ions; atomic particles; sub-atomic particles; x-rays; and the like.

In one aspect of the invention, the monitors 18 may also include some form of means for detecting barriers, for example, a sonic- or electromagnetic-based, for determining the relative location and/or distance to a wall or ceiling. In one aspect of the invention, the information obtained from the means for detecting barriers may be combined with the means for determining distance 16 to determine if a member 12 of a group is within the same room or floor of the member 14 of the group. For example, in one aspect, if member 14 is located behind a wall (not shown), monitor 18 may be adapted to not emit an alarm when a distance deviation is detected. In another aspect, monitor 18 may include an indication of the presence of a barrier. In another aspect of the invention, monitor 18 may provide an indication of the likelihood that another member is accessible, due to the presence of a barrier, such as a wall. For example, in one aspect, monitor 18 may emit one audible or visual alarm, for example, having first pitch, if no obstructions or barriers are detected between one monitor 18, and another monitor 18, and emit a second audible or visual alarm, for example, having a second pitch, when an obstruction or barrier is detected.

In one aspect of the invention, monitors 18 may include at least one electronic controller, for example, a microcontroller, adapted to regulate the transmission of signals and the reception of signals by monitor 18. In one aspect, the controller receives one or more input signals and, based on predetermined parameters, controls one or more output signals accordingly. For example, in one aspect of the invention, the microcontroller in monitor 18 may be adapted to transmit a signal for a first period of time, for example, for about 0.001 seconds, and then receive (or “listen for”) a signal for a second period of time, for example, for about 0.999 seconds. According to one aspect of the invention, the controller in monitors 18 may be adapted to detect and characterize a signal received to at least approximate the relative proximity, or distance of separation 16, of one monitor 18 from another monitor 18 associated with the group 10. According to one aspect of the invention, monitor 18 is adapted to emit a signal when the distance of separation 16 of one monitor relative to at least one other monitor exceeds a predetermined distance, for example, at least about 5 feet. In one aspect of the invention, the predetermined distance may vary due to or be a function of an environmental condition, for example, visibility.

FIG. 2 is a schematic diagram of members of a group 22 having at least three members 24, 26, and 28, according to another aspect of the invention. Each member 24, 26, and 28 includes a monitor 18. Members 24, 26, and 28 may be similar to members 12 and 14 discussed above. Members 24 and 26 are separated by a distance 30; members 24 and 28 are separated by a distance 32; and members 26 and 28 are separated by a distance 34. According to one aspect of the invention, monitors 18 are again adapted to transmit and receive signals (not shown), for example, similar to signal 20 in FIG. 1, and are adapted to emit a signal, for example, similar to signal 21, when at least one of distances 30, 32, or 34 exceeds or is less than a predetermined distance. Again, the predetermined distance may be characterized by a characteristic of the signals received by monitors 18. For example, according to one aspect of the invention, assuming distances 32 and 34 are greater than distance 30, when at least one of distances 32 or 34 exceeds a predetermined distance, for example, 10 feet, at least one of the monitors 18 associated with member 24, 26, or 28 may emit a signal advising at least one of members 24, 26, and 28 that member 28 has separated from group 22. In one aspect, when this condition occurs, the monitor 18 associated with member 28 may emit a high-pitched siren and/or a flashing light that can be heard or seen by members 24 and/or 26.

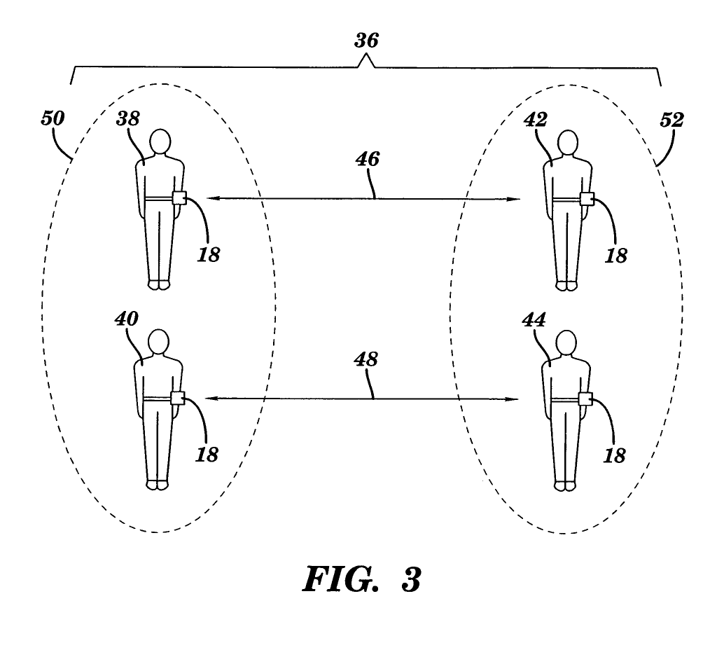

FIG. 3 is a schematic diagram of a group 36 having members 38, 40, 42, and 44 according to another aspect of the invention. FIG. 3 illustrates the aspect of the invention whereby one or more subgroups may be formed from a group 36. As before, members 38, 40, 42, and 44 each bear a monitor 18. Members 38 and 42 are separated by a representative distance 46 and members 40 and 44 are separated by a representative distance 48. The respective distances between other members of the group are omitted from FIG. 3 for the sake of clarity. According to this aspect of the invention, at least one member of group 36 may separate from group 36 to create one or more subgroups, for example, subgroups 50 and 52 demarcated by phantom ovals in FIG. 3. For example, in the aspect of the invention shown in FIG. 3, members 42 and 44 may separate from group 36 to create subgroup 52, while the remaining members 38 and 40 in group 36 may define a subgroup 50 of group 36. According to this aspect of the invention, subgroups 50 and 52 may comprise substantially independent subgroups. For example, though once members 42 and 44 may have been members of group 36 whereby when distances of separation 46 and 48 exceeded a predetermined distance whereby at least one monitor 18 may emit a signal, according to one aspect of the invention, monitors 18 may be adapted to recognize independent subgroups 50 and 52 whereby no signal is initiated when distances 46 and/or 48, for example, exceed a predetermined distance. Moreover, monitors 18 may be adapted to initiate a signal when members 42 and 44 of group 52 are separated by a distance exceeding a predetermined distance or less than a predetermined distance.

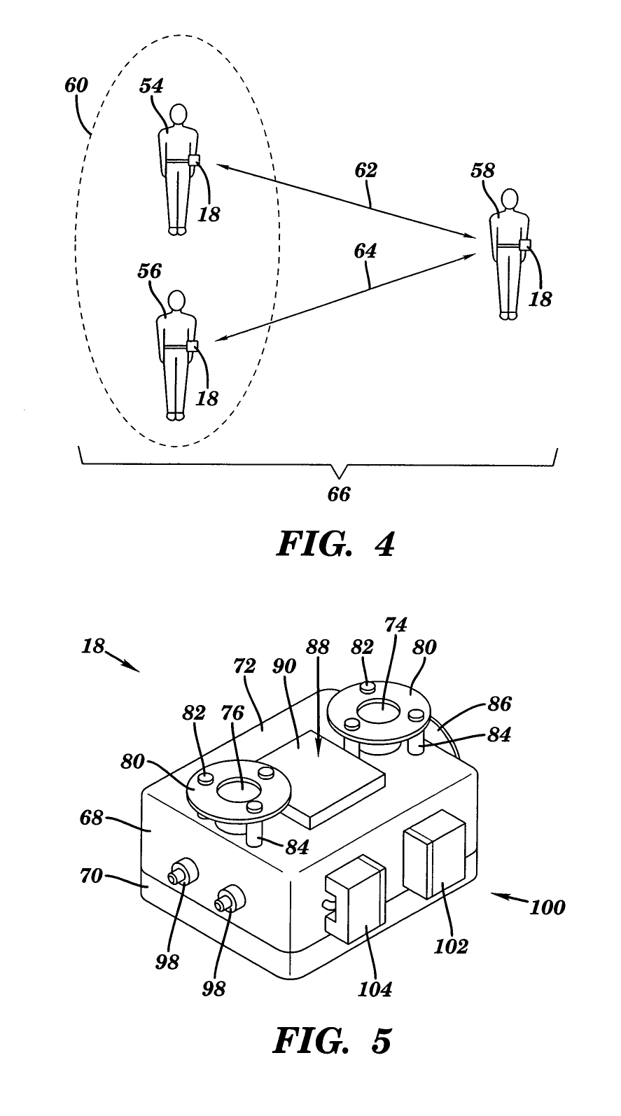

FIG. 4 is a schematic diagram of a group 60 having members 54 and 56 and one or more separate individuals 58 not associated with group 60 according to another aspect of the invention. FIG. 4 illustrates the aspect of the invention whereby one or more individual or groups 58 may join an existing group 60. As before, members 54, 56, and 58 each bear a monitor 18. Member 54 and individual 58 are separated by a representative distance 62 and members 56 and individual 58 are separated by a representative distance 64. Again, the respective distances between other members of the group are omitted from FIG. 4 for the sake of clarity. According to this aspect of the invention, at least one individual 58 or group 58 may join group 60 to create a larger group 66. For example, in the aspect of the invention shown in FIG. 4, monitors 18 may be adapted whereby one or more independent individuals 58, that is, an individual not substantially associated with group 60, may join group 60 to create group 66 whereby monitors 18 may monitor distances of separation 62, 64 to determine when distances 62, 64 exceed a predetermined distance. Again, according to this aspect of the invention, when at least one monitor 18 detects that distances of separation 62, 64 exceed a predetermined distance, at least one monitor 18 may emit a signal notifying at least one of members 54, 56, and 58 that the predetermined distance of separation has been exceeded. In one aspect, individual 58 may be a member of another group, different from group 60, and join group 60 to provide a new larger group 66.

In one aspect of the invention, monitors 18 shown in FIGS. 1 through 4 may be monitored by one or more centralized monitors (not shown), for example, a monitor positioned external to or at a distance from the structure or location in which members having monitors 18 are located. For example, in one aspect, monitors 18 (or any monitor disclosed herein) may be monitored by an external monitor providing a “command post” from which at least some, typically all, the monitors 18 may be located, for example, by the fire chief at a fire scene. This centralized monitor may provide visual display of the position of monitors 18 and, for example, obstacles, walls, or obstructions present near or about the location of monitors 18. The external monitor may communicate with monitors 18 and their respective group members by one or more of the communication methods discussed herein, for example, by radio frequency (RF) communication means, infrared (IR) communication means, audible means, or visual means, among other means of communication. In one aspect of the invention, the centralized monitor may communicate with the monitors 18 to provide information, for example, the status or location of members, the state of the fire or crime scene, warnings and alarms, or any other information that may be useful to the members wearing monitors 18. In one aspect, the centralized monitor may provide information to monitors 18 which may vary the operation of monitors 18, for example, the centralized monitor may provide information that varies the predetermined distance that regulate the operation of monitors 18, among other modes of operation.

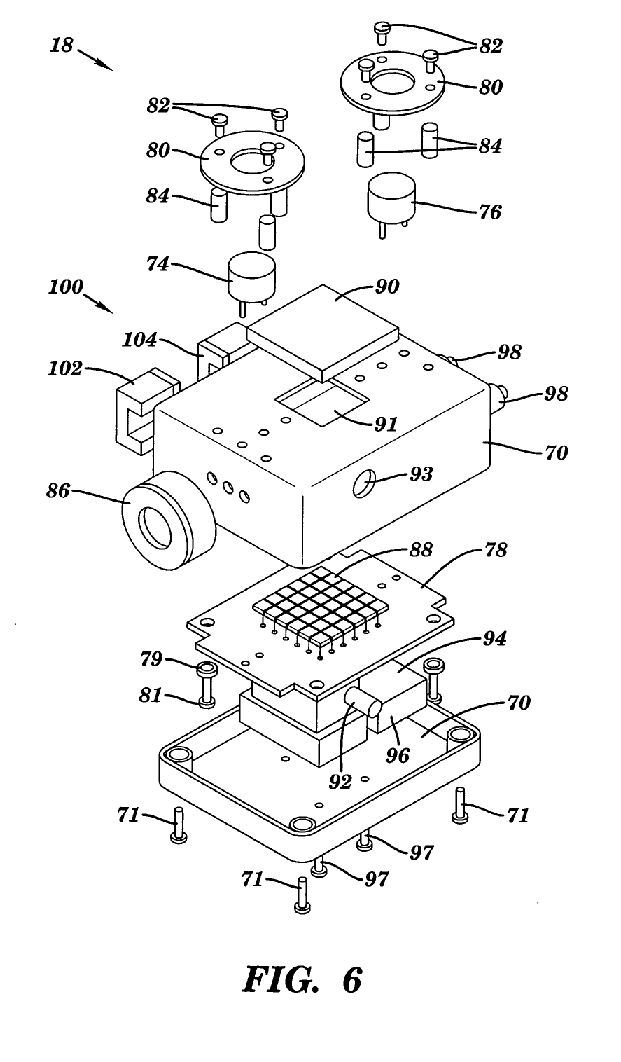

FIG. 5 is a perspective view of a typical monitor 18 according to one aspect of the invention that may be used for monitor 18 shown in FIGS. 1 through 4. FIG. 6 is an exploded perspective view of the monitor 18 shown in FIG. 5 rotated 90 degrees about the vertical axis. Monitor 18 comprises a housing 68 having a base 70 and a cover 72. Housing 68 protects the electronic components of monitor 18, for example, from excessive shock, excessive temperature, moisture, harsh chemicals, and the like. Housing 68 may be metallic or non-metallic, for example, housing 68 may be made from steel, stainless steel, aluminum, titanium, or any other structural metal. Housing 68 may also be made from a polyamide (PA), for example, nylon; a polyethylene (PE); a polypropylene (PP); a polyester (PE); an acrylonitrile butadiene styrene (ABS); a polyvinylchloride (PVC); or a polycarbonate (PC); among other plastics. Cover 72 may be mounted to base 70 by conventional means, for example, by means of snap fit or mechanical fasteners, for instance, by means of screws 71.

Though not shown in FIGS. 5 and 6, housing 68 of monitor 18 may typically include at least one means for attaching monitor 18 to an individual. For example, housing 68 may include a loop or ring by which monitor 18 may be mounted to a belt or harness, or housing 68 may include a strap, sling, lanyard, and the like, for grasping or mounting monitor 18.

Monitor 18 may typically include a signal detecting transducer, or detector, 74 that is, a device adapted to detect a signal emitted from one or more other monitors 18 and convert the signal into an electrical signal, for example, a 4-20 milliamp (mA) DC signal that can be transmitted to a controller in monitor 18. Monitor 18 may also typically include a signal emitting transducer, or emitter, 76 that is, a device adapted to emit one or more signals that may be detected by one or more other monitors 18, for example, based upon an electrical signal, for example, a 4-20 mA signal transmitted by a controller. In one aspect of the invention, detector 74 and emitter 76 may be adapted to detect and emit, respectively, electromagnetic radiation or sonic waves. In one aspect of the invention, detector 74 and emitter 76 may be adapted to detect and emit, respectively, ultrasonic signals, for example, signals having a frequency between about 20 k Hz and about 200 kHz. In one aspect of the invention, detector 74 may be a model 250ER250 detector provided by APC International, Ltd. of Mackeyville, Pa., or its equivalent, and emitter 76 may be a 250ET250 emitter provided by APC International, Ltd., or its equivalent.

Detector 74 and emitter 76 may be mounted to housing 68 by conventional means, for example, by means of one or more pins which penetrate housing 68 and engage one or more holes in printed circuit board 78 (discussed below). Detector 74 and emitter 76 may also be protected from damage by one or more shields 80, for example, one or more circular rings or washers, mounted to housing 68 by means of mechanical fasteners, such as screws 82 and standoffs 84.

In one aspect, monitor 18 may also include a controller (not shown?) for example, a microcontroller mounted on printed circuit board (PCB) 78. In one aspect of the invention, the controller may be a digital signal processor micro controller hybrid, for example, a controller fabricated by Freescale Semiconductor, Inc. of Austin, Tex., or its equivalent, though other controllers may be used. According to one aspect of the invention, the controller on PCB 78 may be adapted to receive the electrical signal transmitted by detector 74 and to detect at least one characteristic of the signal received that can be used to at least approximate the distance of separation of monitor 18 from other monitors 18. For example, the controller may be adapted to determine the signal strength, signal phase, signal shape, or other distance related characteristic, property, or information of the signal or signals received from one or more other monitors 18. According to one aspect of the invention, the controller on PCB 78 may also be adapted to transmit an electrical signal to a signaling device, for example, a light or siren (discussed below) when the predetermined distance of separation is exceeded. PCB 78 may be mounted to housing 68 in a conventional manner, for example, by means of circuit board grommets 79 and screws 81. In one aspect, grommets 79 may be serial number 730 grommets provided by Mouser Electronics of Mansfield, Tex., though other types of grommets may be used.

The controller on PCB 78 may also be adapted to forward an electrical signal, for example, a 4-20 milliamp (mA) signal, to emitter 76 whereby emitter 76 emits a signal that that can be detected by a detector in one or more other monitors 18 (such as detector 74 above). The controller on PCB 78 may be adapted to transmit an electrical signal to emitter 76 whereby a signal is emitted from emitter 76 during a first time period. The controller may also receive an electrical signal from detector 74 whereby a signal is received by detector 74 during a second time period, longer or shorter than the first time period for which a signal is emitted by emitter 76. The controller may be configured to alternate between emitting a signal from emitter 76 and receiving a signal from detector 74.

Monitor 18 may also include one or more signaling devices that may be used to advise at least one member of a group when the distance of separation of a member has exceeded the predetermined distance. For example, as shown in FIGS. 5 and 6, monitor 18 may include at least one audible signal-emitting device 86. Audible signal emitting device 86 may be any device adapted to emit an audible signal when directed, for example, by the controller on PCB 78. In one aspect of the invention, audible signal emitting device 86 may be any type of sound transducer adapted to emit an audible sound when excited by an electrical signal, for example, audible signaling device 86 may be a siren, a bell, or like audible device. In one aspect of the invention, audible signal emitting device 86 may be piezo sound transducer, for example, a PT-3534FP piezo sound transducer provided by Mallory Sonalert Products, Inc. of Indianapolis, Ind., though other audible signal emitting devices may be used.

In one aspect of the invention, monitor 18 may include a device that emits a signal in a human language, for example, English, which can be understood by one or more members of the group. In one aspect, monitor 18 may include a processor, and an appropriate speaker, adapted to emit a voice signal, for example, announcing the distance of the wearer from at least one other member of the group, or the physical condition of the wearer, or the presence of a hazardous condition, such as toxic fumes or heavy smoke, among other possible messages or warnings.

Monitor 18 may also include one or more visual signal emitting devices 88. Visual signal emitting device 88 may be any device adapted to emit a visual signal, for example, light, when directed, for example, by the controller on PCB 78. In one aspect of the invention, visual signal emitting device 88 may be any type of transducer adapted to emit an visual light when excited by an electrical signal, for example, visual signaling device 88 may be one or more incandescent lights, fluorescent lights, or light-emitting diodes (LEDs), strobe lights, black lights, infrared lights or a “beacon”, or like visual device. In one aspect of the invention, visual signal emitting device 88 may be an array of LEDs, for example, an array of 2 or more, for example, 9 or more, 5 mm orange LEDs having a part number TL0E17TP provided by Marktech Optoelectronics of Menands, N.Y., though other visual signal emitting devices may be used. As shown in FIG. 5, the array of LEDs 88 may be mounted to PCB 78 in a conventional manner, for example, by means of pins that engage holes in PCB 78.

Visual signal emitting device 88 may be positioned beneath a surface of housing 68 through which the emitted light will pass, for example, a surface translucent or transparent to the electromagnetic radiation emitted by the visual signal-emitting device. For example, in one aspect of the invention, at least a section of housing 68 may made from a material through which the emitted radiation may pass, for example, a transparent surface of housing 68. As shown in FIGS. 5 and 6, in one aspect of the invention, a transparent window 90 may be positioned over an aperture 91 above the visual signal-emitting device 88, for example, a transparent plastic or glass window. In one aspect, window 90 may be made from a clear polycarbonate resin, for example, GE's Lexan® polycarbonate resin, or its equivalent. Window 90 may be mounted to housing 68 by conventional means, for example, by means of an adhesive or one or more mechanical fasteners.

Monitor 18 may also include an electromagnetic energy transceiver 92 for transmitting from monitor 18 or receiving to monitor 18 an electromagnetic signal, for example, a radio frequency (RF) signal. In one aspect, transceiver 92 may be used to transmit a radio frequency identification tag to other members or to a central command station, for example, to track the location of monitor 18, and thus the wearer. In another aspect of the invention, transceiver 92 may be adapted to emit an RF signal at essentially the same time that monitor 18 emits a ultrasonic signal. As discussed above, this RF signal and this ultrasonic signal may be used by another monitor 18 to detect the relative time of arrival (TOA) of the signals to provide an indication of the distance of separation of the monitors 18. Transceiver 92 may also be used to provide a radio frequency identification tag receivable by other devices, for example, for use in other applications, such as absolute location monitoring applications. In one aspect of the invention, transceiver 92 may an SC-PA RF transceiver provided by Linx Technologies of Grants Pass, Oreg., though other transceivers may be used for this invention. As shown in FIGS. 5 and 6 a penetration 93 in housing 68 may be provided to emit the signal from transceiver 92.

Monitor 18 may be powered by any conventional power source 94, for example, conventional AC voltage, batteries, power cells, or fuel cells, among others. In the aspect of the invention shown in FIG. 6, power source 94 may comprise one or more conventional batteries, for example, one or more 9 VDC batteries. Power source 94 may be mounted in a power source holder 96, for example, a battery holder. Power source holder 96 may be mounted to housing 68 by conventional means, for example, mechanical fasteners 97. Power source 94 may be activated by one or more switches 98 (see FIG. 5), for example, one or more on/off switches, positioned in housing 68 and adapted to energize monitor 18 when, for example, depressed. In one aspect of the invention, switches 98 may be switches having a part number S12PB-N0 provided by Digikey Corporation of Thief River Falls, Minn., or their equivalent, though other types of switches may be used.

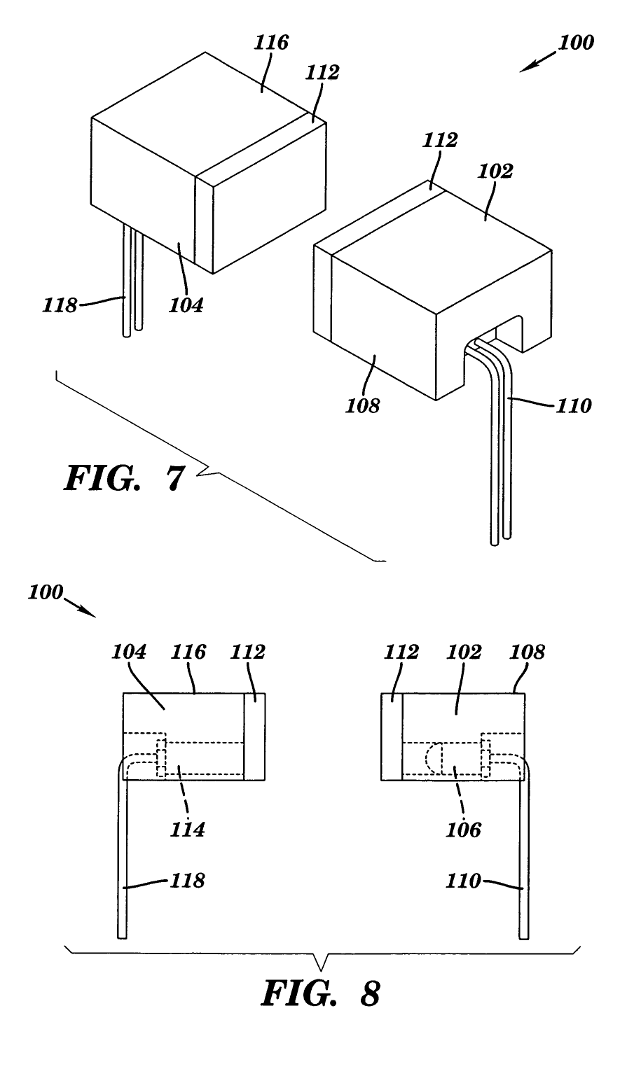

Monitor 18 may also include one or more visibility sensors 100. In one aspect of the invention, visibility sensor 100 provides an indication of the visibility in the environment in which monitor is being used, for example, how much smoke is present at the scene of a fire. As shown in FIGS. 5 and 6, in one aspect, visibility sensor 100 may include a light source 102 and light detector 104. Details of light source 102 and light detector 104 are shown in FIGS. 7 and 8.

FIG. 7 is a perspective view of one visibility sensor 100 having light source 102 and light detector 104 that may be mounted to monitor 18 according to one aspect of the invention. FIG. 8 is a front elevation view of visibility sensor 100 shown in FIG. 7. In one aspect of the invention light source 102 may be any visible light source that may be detected by detector 104. In one aspect, light source 102 comprises at least one LED 106 (shown in phantom in FIG. 8), for example, a red light LED, mounted in a cavity in light source housing 108. As shown in FIG. 8, LED 106 may include electrical leads 110 that, for example, may penetrate housing 68 of monitor 18 to connect to PCB 78. Light source 102 may also include a transparent cover 112, for example, a clear plastic cover, such as a Lexan® cover. In one aspect of the invention detector 104 may be any detector adapted to detect light emitted by light source 102 and produce an electrical signal. In one aspect, detector 104 comprises at least one photo detector 114 (shown in phantom in FIG. 8), for example, a matched visible light detector, mounted in a cavity in light detector housing 116. In one aspect, photo detector 114 may be a photo detector having a part number EE-XX1046 supplied by Mouser Electronics, Inc, of Mansfield, Tex., or its equivalent, though other types of photo detectors may be used. As shown in FIG. 8, photo detector 114 may include electrical leads 117 that, for example, may penetrate housing 68 of monitor 18 to connect to PCB 78. Detector 104 may also include a transparent cover 112, for example, a clear plastic cover, such as a Lexan® cover having a thickness of about ⅛^{th} of an inch. Light source housing 108 and detector housing 116 may be mounted to monitor housing 68 by conventional means, for example, by means of an adhesive, snap fit, or mechanical fasteners. In one aspect of the invention, light source housing 108 and detector housing 116 may be about the same size, for example, about 0.75 inches in length, about 0.550 inches in height and abut 1.0 inches in width.

Monitor 18 may also include other types of detectors or sensors, for example, one or more environmental sensors or ambient condition sensors, for instance, one or more temperature sensors, one or more oxygen sensors, one or more gas sensors, and the like. Monitor 18 may also include one or more health monitoring sensors for detecting the health status of the individual wearing monitor 18, for example, a heart rate monitor, a blood pressure monitor, and the like. The health monitoring sensors may include one or more leads as appropriate which can be attached to appropriate locations of the users body. These sensors may be mounted on the external surface or within housing 68 and be provided with appropriate electrical interfaces with the controller on PCB 78.

Monitor 18 may also include one or more user interfaces (not shown in FIGS. 5 and 6) through which the user can, for example, manually input information into and may also provide output from monitor 18. Monitor 18 may also include one or more on/off buttons, reset buttons, and buttons having related functions, and the like.

The size of monitor 18 may vary and its size is primarily a function of the size of the components housed in housing 68 and the size of the user interface, for example, the size of the interface buttons that can be activated, for example, manually, by the user. In one aspect of the invention, housing 68 may be rectangular, square, triangular, or circular, among other shapes, and have dimensions varying from as small as about 0.25 inches to as large as about 1 foot. However, in one aspect of the invention, monitor 18 may be a parallelepiped in shape, and have a length of between about 2 inches and about 10 inches, typically, between about 3 inches and about 6 inches, for example, about 4.5 inches; a width of between about 2 inches and about 10 inches, typically, between about 3 inches and about 5 inches, for example, about 3.5 inches; and a height of between about 2 inches and about 10 inches, typically, between about 1.5 inches and about 4 inches, for example, about 2.25 inches.

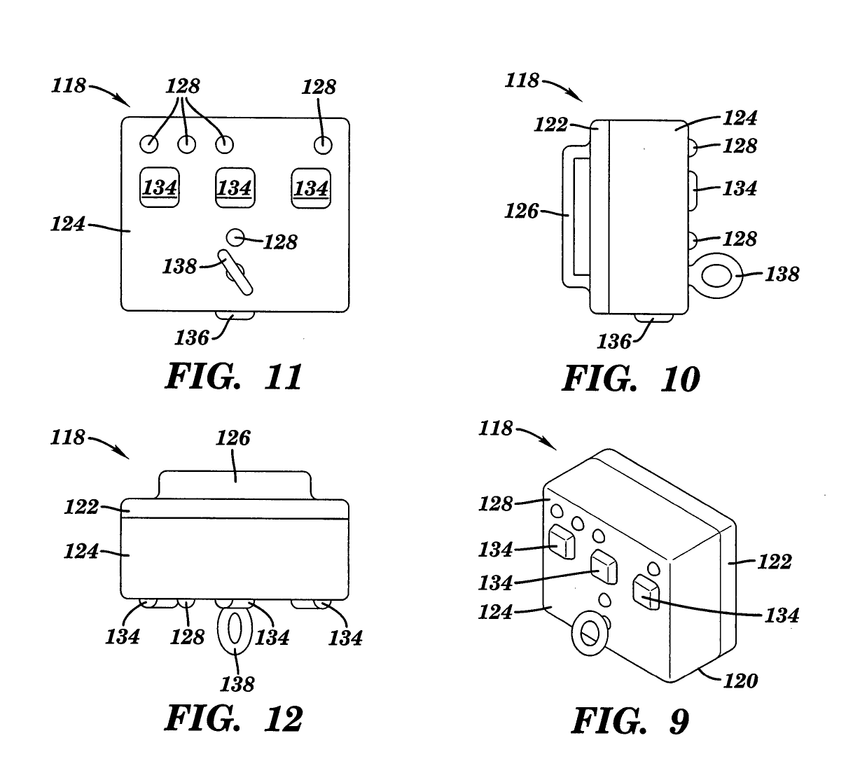

FIGS. 9 through 16 illustrate two other monitors 118, 218 according to other aspects of the invention. FIG. 9 is a perspective view of another monitor 118 according to another aspect of the invention. FIG. 10 is a left side elevation view of monitor 118 shown in FIG. 9. FIG. 11 is a front elevation view of monitor 118 shown in FIG. 9. FIG. 12 is a top plan view of monitor 118 shown in FIG. 9. Monitor 118 comprises a housing 120 having a base 122 and a cover 124, similar to housing 68 of monitor 18, discussed above. Housing 120 protects the electronic components of monitor 118, for example, from excessive shock, excessive temperature, moisture, harsh chemicals, and the like. Similar to housing 68, housing 120 may be metallic or non-metallic, for example, one or more of the metals or plastics listed above with respect to housing 68. Cover 124 may be mounted to base 122 by conventional means, for example, by means of snap fit or mechanical fasteners, for instance, by means of screws (not shown).

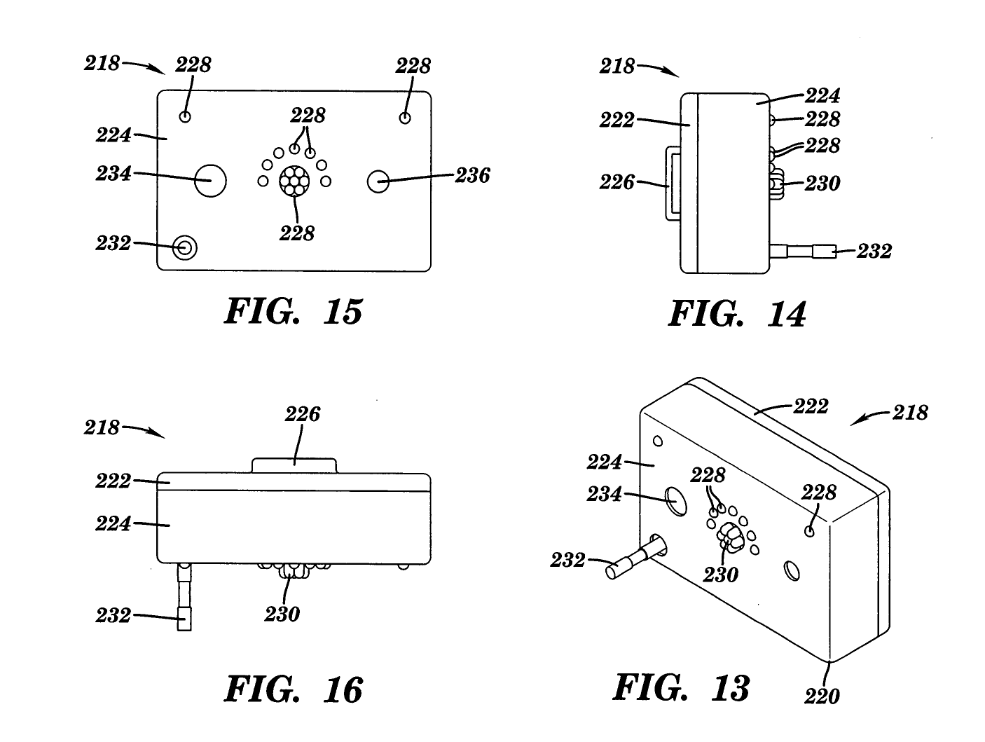

FIG. 13 is a perspective view of another monitor 218 according to another aspect of the invention. FIG. 14 is a left side elevation view of monitor 218 shown in FIG. 13. FIG. 15 is a front elevation view of monitor 218 shown in FIG. 13. FIG. 16 is a top plan view of monitor 218 shown in FIG. 13. Monitor 218 comprises a housing 220 having a base 222 and a cover 224, similar to housing 68 of monitor 18, discussed above. Housing 220 protects the electronic components of monitor 218, for example, from excessive shock, excessive temperature, moisture, harsh chemicals, and the like. Similar to housings 68 and 120, housing 220 may be metallic or non-metallic, for example, housing 220 may be made from one or more of the metals or plastics listed above with respect to housing 68. Cover 224 may be mounted to base 222 by conventional means, for example, by means of snap fit or mechanical fasteners, for instance, by means of screws (not shown).

As shown in FIGS. 9 through 16 housings 120 and 220 of monitor 118 and 218, respectively, may typically include at least one means for attaching monitor 118, 218 to an individual. For example, housings 120, 220 may include a belt loop or ring 126, 226, respectively, by which monitors 118, 218 may be mounted to a belt or harness, or housings 120, 220 may include a strap, sling, lanyard, and the like, for grasping or mounting monitors 118, 218, respectively.

Similar to monitor 18, monitors 118 and 218 may typically include a signal detecting transducer, or detector (not shown), that is, a device adapted to detect a signal emitted from one or more other monitors 18, 118, 218, and convert the signal into an electrical signal, for example, a 4-20 milliamp (mA) DC signal that can be transmitted to a controller in monitors 118, 218. Monitors 118 and 218 may also typically include a signal emitting transducer, or emitter (not shown), that is, a device adapted to emit one or more signals that may be detected by one or more other monitors 18, 118, 218, for example, based upon an electrical signal, for example, a 4-20 mA signal transmitted by a controller in monitors 118 and 218. In one aspect of the invention, the detector and emitter in monitors 118 and 218 may be adapted to detect and emit, respectively, electromagnetic radiation, or sonic energy, for example, as described above with respect to monitor 18.

Again, similar to monitor 18, monitors 118 and 218 may also include a controller (not shown), for example, a microcontroller mounted on a PCB (not shown), for example, a controller and PCB similar to PCB 78 discussed above with respect to monitor 18. The controller in monitors 118 and 218 may be adapted to receive the electrical signal transmitted by a detector and to determine at least one characteristic of the signal received that can be used to at least approximate the distance of separation of monitor 118, 218 from other monitors 18, 118, 218. For example, the controller may be adapted to determine the signal strength or TOA of the signal or signals received from one or more other monitors 18, 118, and 218. According to one aspect of the invention, the controller in monitors 118 and 218 may also be adapted to transmit an electrical signal to a signaling device, for example, a light or siren, when the characteristic of the received signal deviates from a predetermined characteristic.

Again, similar to monitor 18, the controller in monitors 118 and 218 may also be adapted to forward an electrical signal to an emitter whereby the emitter emits a signal that that can be detected by a detector in one or more other monitors 18, 118, or 218 (such as detector 74 above). The controller in monitors 118 and 218 may be adapted to transmit an electrical signal to an emitter whereby a signal is emitted from the emitter during a first time period. The controller may also receive an electrical signal from a detector in monitors 118 and 218 whereby a signal is received by the detector during a second time period, longer or shorter than the first time period for which a signal is emitted by the emitter. The controller may be configured to alternate between emitting a signal from the emitter and receiving a signal from the detector.

Monitors 118 and 218 may also include one or more signaling devices that may be used to advise at least one member of a group when the distance of separation of a member has exceeded the predetermined distance. For example, similar to monitor 18, monitors 118 and 218 may include one or more audible signal emitting devices (not shown), for example, one or more sound transducers adapted to emit an audible sound when excited by an electrical signal, for instance, a siren, a bell, or like audible device. In one aspect of the invention, the signaling device may be a palpable signal, for example, a signal that can be felt or physically sensed by a member of the group, for example, a device that vibrates or emits other palpable signals.

Monitors 118 and 218 may also include one or more visual signal emitting devices. As described with respect to monitor 18, a visual signal emitting device may be any device adapted to emit a visual signal, for example, light, when directed, for example, by the controller in monitor 118 and 218. In one aspect of the invention, visual signal emitting devices in monitors 118 and 218 may be any type of transducer adapted to emit a visual light when excited by an electrical signal, for example, one or more incandescent lights, fluorescent lights, or light-emitting diodes (LEDs), strobe lights, black lights, infrared lights or “beacon”, or like visual device. As shown in FIGS. 9 through 13, monitor 118 may include one or more LEDs 128. As shown in FIGS. 13 through 16, monitor 218 may include one or more LEDs 228. LEDs 128 and 228 may be provided by Marktech Optoelectronics of Menands, N.Y. As shown in FIGS. 13 through 16, monitor 228 may include visual signaling device comprising one or more strobe lights 230, for example, an infrared (IR) strobe light.

Monitors 118 and 218 may also include an electromagnetic energy transceiver, for example, a transceiver similar to transceiver 92 discussed above with respect to monitor 18. The transceiver may be adapted for transmitting an electromagnetic signal from monitors 118 and 218 or receiving an electromagnetic signal to monitors 118 and 218, for example, a radio frequency (RF) signal. As shown in FIGS. 13 through 16, monitor 218 may include a transceiver having an antenna 232 that projects through a perforation in housing 220. In FIGS. 9 through 13, the transceiver in monitor 118 is not shown or may be omitted from monitor 118.

Monitors 118 and 218 may be powered by any conventional power source (not shown), for example, conventional AC voltage, batteries, power cells, or fuel cells, among others. The power source in monitors 118 and 218 may be activated by one or more buttons or switches, for example, one or more on/off switches 134 on monitor 118 and one or more switches 234, for example, rocker switches, on monitor 218.

Monitors 118 and 218 may also include one or more visibility sensors (not shown), for example, one or more visibility sensors similar to sensor 100 described with respect to monitor 18 and illustrated in FIGS. 7 and 8.

Monitors 118 and 218 may include one or more user interfaces, for example, buttons, switches, or other means by which a user may input data or information, for example, for turning monitors 118 and 218 on and off, for resetting the operation of monitors 118 and 218, or for inputting user information (for example, user identification numbers) or other data or information. As shown in FIGS. 9 through 12, monitor 118 may include one or more push buttons 134, for example, 3 push buttons. Push buttons 134 may be used to silence an alarm. Buttons 136 and 236 in FIGS. 9 through 12 and FIGS. 13 through 16, respectively, may be reset buttons for resetting the operation of monitors 118 and 218, respectively. In one aspect of the invention, monitors 118 and 218 may include a removable pin which activates the monitor when removed. For example, as shown in FIGS. 9 through 12, monitor 118 may include a ring 138 attached to a removable pin which when grasped and pulled out by the user activates monitor 118. In one aspect, reinserting the pin attached to ring 138 may deactivate monitor 118. In another aspect, ring 138 may be attached to a point of entry accountability tag, for example, monitor 118 may be activated with the removal of ring 138. In one aspect, monitor 118 may be shut down or put into standby with reunion or reinsertion of the point of entry accountability tag. In one aspect of the invention, monitor 18 may be activated when released or removed from a charging tether or docking station, for example, a charging tether or docking station mounted in an emergency vehicle or fire truck. In another aspect of the invention, monitor 118 may be activated in response to an environmental condition, for example, in response to a hazardous environmental condition, such as the presence of noxious or toxic gases or smoke.

Monitors 118 and 218 may also include one or more user interfaces through which the user can, for example, manually input information into the controller of the monitors 118 and 218 and/or provide user recognized output from monitors 118 and 218. Monitors 118 and 218 may be comparable in size and shape to monitor 18 described above.

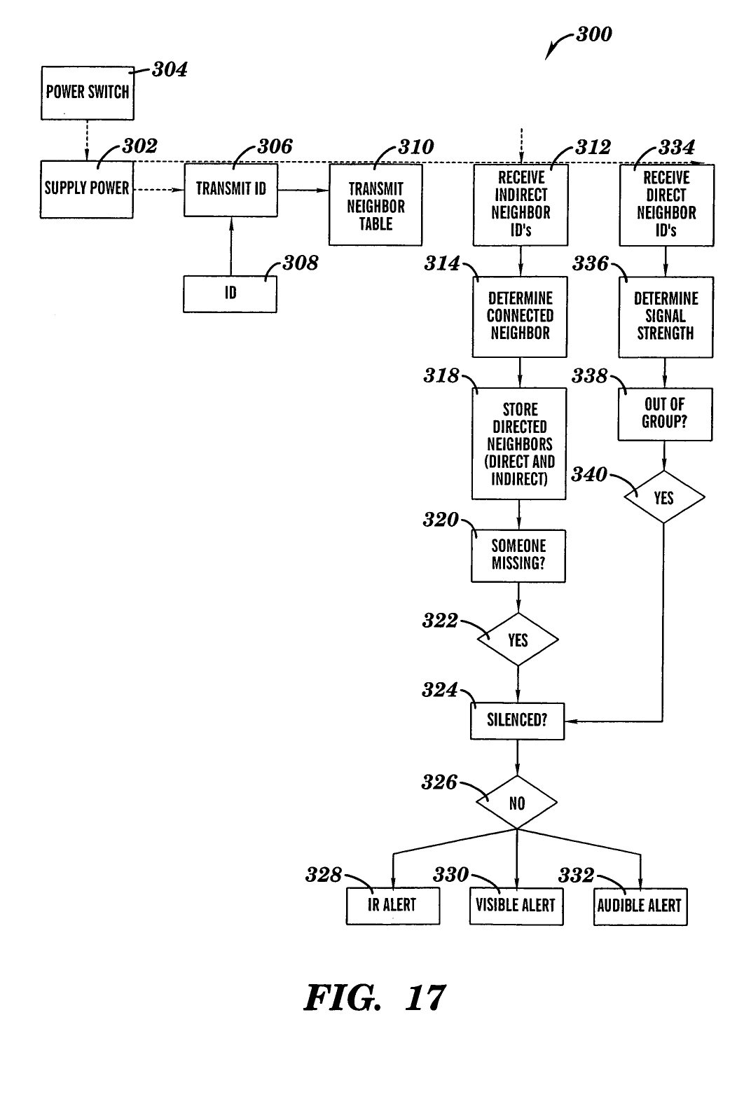

FIG. 17 is a block diagram 300 of the functions of one aspect of the present invention. Block diagram 300 represents the functions of an aspect of the invention which provides a wireless system by which at least two individuals or members of a group, such as members 12 and 14 in group 10 of FIG. 1, may maintain close proximity, for example, maintain a network to enhance the safety or survivability of each member. This aspect of the invention allows one or more members of a group to track the relative location of the member to one or more other members of the group, or network, and alert members of the group when the distance of separation between a member of the group and at least one other member exceeds a predetermined maximum distance of separation. The predetermined distance of separation may be, for example, a distance of 5 feet or less, a distance of 10 feet or less, or a longer distance. According to this aspect of the invention, the individual members of the group, for example, individual humans, each bears a signal-transmitting/signal-receiving monitor, for example, a monitor such as monitor 18, 118, or 218 described above.

With reference to block diagram 300, according to one aspect, the system of the invention is initiated by energizing or providing electrical power to each of the monitors, as represented by block 302. Power may be provided by pressing a power switch on each of the monitors, as indicated by block 304. In one aspect, power may be provided automatically, for example, in response to an environmental condition or simply by movement of the monitor. In one aspect of the invention, each monitor transmits a signal representing the identification of each monitor to each of the other monitors in the group. This is represented by blocks 306 and 308, where block 308 represents the transmission of an identification signal from one monitor to another monitor.

In one aspect of the invention, as indicated by block 310, monitors may receive data for all the monitors in the work area, for example, at the scene of the fire, for instance, in the form of a table of data or information. This data may be transmitted from one monitor or from one central control station coupled with the monitors. This may comprise a “master list” of members in the work area of each monitor. This data may also include a predetermined threshold distance of separation or signal characteristic of the threshold distance that can be tolerated by the system. Again, this threshold distance may be a function of the prevailing ambient conditions, for example, visibility or toxicity. As indicated by block 312, in one aspect, each monitor may receive data from “indirect neighbors,” for example, members that are not associated with the group a monitor is associated with. The monitors then may determine which members are “connected,” or are members of a group, as indicated by block 314. Then, in one aspect, data or information related to the connected members, for example, both direct and/or indirect members, may be stored in the controller of each monitor for later use, as indicated by block 318. As indicated by block 320, in one aspect, each monitor may compare the members in the master list to the connected members, both direct and indirect members, to determine if all members (or neighbors) are accounted for. If, as indicated by decision block 322, a member on the master list is missing, according to one aspect, the monitor will first determine if the missing member has been “silenced,” as shown by block 324. If the missing member has not been silenced, as indicated by block 326, an alarm sequence will be initiated, as indicated by blocks 328, 330, and 332. For example, as indicated by block 328, a beacon, for example, an infrared or visible beacon, may be activated (which may be constant, flashing, or intermittent) to advise members that one or more members are not accounted for. This beacon may be activated for a first time period, for example, 10 seconds. If after this first time period, the missing member or members have not been located, a second alarm, as indicated by block 330, may be activated, for example, a visible light, for instance, as strobe. This second alarm may be activated for a second time period, for example, 10 seconds. If after this second time period, the missing member or members have still not been located, a third alarm, as indicated by block 332, may be activated, for example, an audible alarm, such as a siren. Again, this third alarm may be activated for a third time period, for example, 10 seconds, or may be activated continuously until the missing member or members are located. At any time, one of these alarms may be manually silenced by any member of the group, for example, by a suspected missing member.

In another aspect of the invention, as indicated by block 334 in FIG. 17, each monitor may receive data or information representing the members or neighbors in a group, that is, the monitors worn by the members associated with the same group. This data may also include the predetermined distanced of separation that can be tolerated between members, for example, 10 feet. Then, according to one aspect, each monitor may determine the characteristic of the received signal from other members of the group, for example, the signal strength of the signal received from other members in the group, as indicated by block 336. As indicated by blocks 338 and 340, should the signal characteristic deviate, for example, exceed the predetermined characteristic, an alarm sequence may be initiated, such as the alarm sequence described above with respect to blocks 324, 326, 328, 330, and 332. Again, when the predetermined characteristic of the received signal, such as the signal strength, conforms to the predetermined threshold characteristic, the alarm sequence may be silenced, for example, by one of the members, as indicated by block 324.

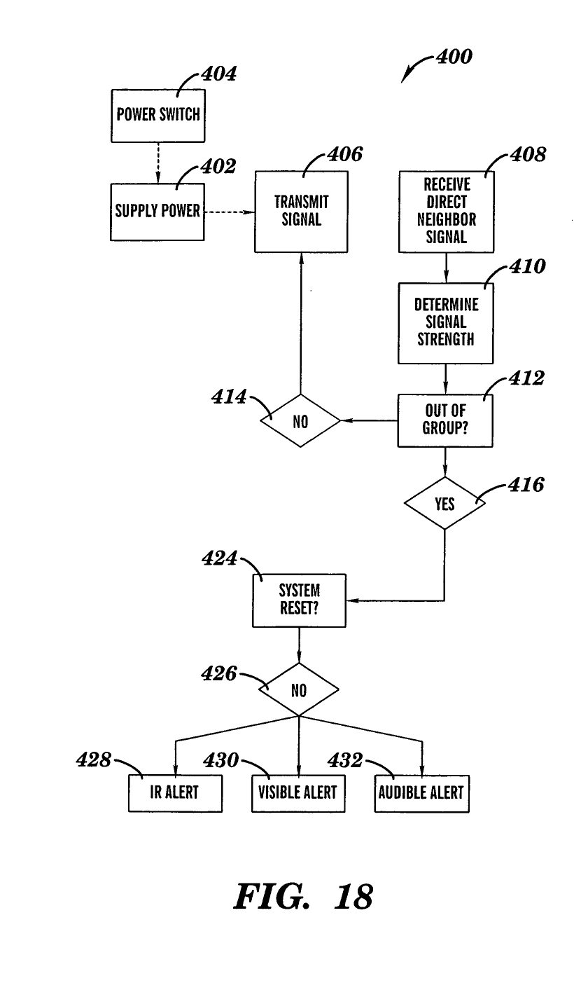

FIG. 18 is a block diagram of the functions of another aspect of the invention. FIG. 18 illustrates a sequence of signal transmissions that monitors the relative location of member of a group, for example, monitors whether members are located within a predetermined distance. In one aspect, this monitoring is practiced by a monitor transmitting a first signal for a first period of time, for example, in a time cycle, while the receiver in the monitor is inactive or disabled. During a second period of time, for example, in a time cycle, the monitors receiver “listens” for one or more signals from other monitors, for instance, by deactivating or disabling the monitor's signal transmission and activating or enabling the monitor's receiver.

As shown in block diagram 400 in FIG. 18, according to one aspect, the system of the invention is initiated by energizing or providing electrical power to each of the monitors, as represented by block 402. Again, the monitor may be monitor 18, 118, or 218 described above. Power may be provided to the monitor by pressing a power switch on each of the monitors, as indicated by block 404, may be powered up automatically, as discussed above. In one aspect of the invention, as indicated by block 406, each monitor transmits a signal for first time period, for example, about 0.001 seconds. Then, as indicated by block 408, for a second time period, for example, about 0.999 seconds, the receiver in the monitor “listens” or receives signals transmitted from one or more other monitors. According to one aspect of the invention, the signals received from one or more other monitors may then be analyzed to determine a characteristic of the received signal, for example, the signal's strength or amplitude, as indicated by block 410. As indicated by block 412, the characteristic, for example, signal strength, may then be compared to a predetermined characteristic level or threshold to determine whether the signal's characteristic deviates from a predetermined value, for example, the signal strength is less than a predetermined signal strength or no signal is received from a monitor. As indicated by block 414, if no deviation from the predetermined characteristic occurs, the process initiated by block 406 is repeated. In one aspect, the monitor's controller continues to send and receive signals, that is, checking for the relative proximity of other monitors. This may be called “normal operation mode.”

According to one aspect, when a deviation does occur, as indicated by block 416, an alarm sequence may be initiated. This may be referred to as initiating “WARNING MODE.” In this mode the module notifies the user (and/or system) that it is outside of the predetermined proximity to another module. The monitor may also continue to transmit and receive other signals. If the module receives adequate signal strength it returns to normal operation mode. The monitor sensing a deviation from a predetermined received signal characteristic may first determine if the monitor sensing the deviation has been “silenced,” as shown by block 424. If the monitor has not been silenced, as indicated by block 426, an alarm sequence will be initiated, as indicated by blocks 428, 430, and 432. For example, as indicated by block 428, an infrared beacon may be activated, for example, a flashing beacon, to advise members that one or more members are beyond the predetermined distance from other members. This infrared beacon may be activated for a first time period, for example, 10 seconds.

If after this first time period, the member has not been returned to an acceptable distance or been found, a second alarm, as indicated by block 430, may be activated, for example, another visible light, for example, a strobe. This mode of operation may be referred to as “ALARM MODE.” In this mode, the module notifies the user and the system that one of the monitors and its wearer continue to be outside of the acceptable distance of separation. In ALARM MODE, the monitor continues to transmit and receive signals and monitor the received signal characteristic, for example, signal strength. If an adequate characteristic is received, the module returns to normal operation mode. This second alarm may be activated for a second time period, for example, 10 seconds.

If after this second time period, the member has not been returned to an acceptable distance or been found, a third alarm, as indicated by block 432, may be activated, for example, an audible alarm, such as a siren. Again, this third alarm may be activated for a third time period, for example, 10 seconds, or may be activated continuously until the member has been returned to an acceptable distance or been found. At any time, one of these alarms may be manually silenced by any member of the group, for example, by a suspected missing member.

According to one aspect of the invention, the system may be reset at any time by any member, for example, by means of user interface on the monitor, for example, a reset button. The reset discontinues the notification or alarm system, and may initiated a monitor “standby mode” for a set period of time.

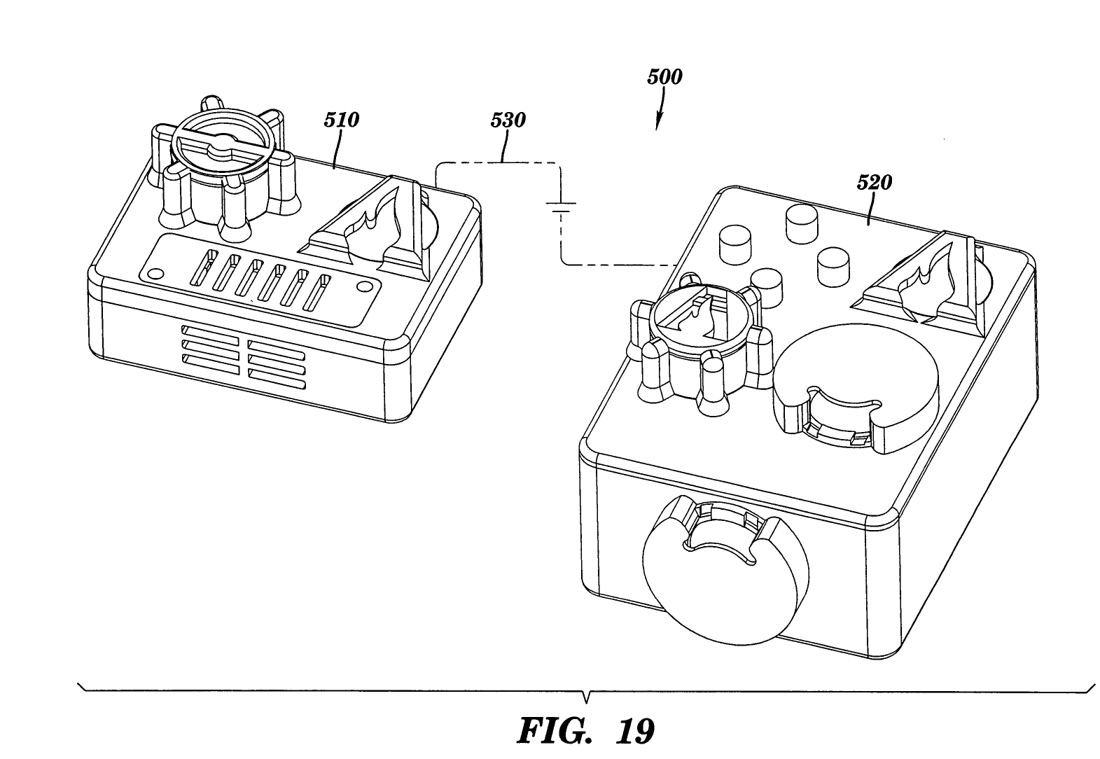

FIG. 19 is a perspective view of a monitor system 500 having two housings 510 and 520 according to another aspect of the invention. System 500 is one system marketed by TekAlert of Troy, N.Y. Housing 510 may comprise a “satellite housing” and housing 520 may comprise a “main housing.” Though two housings 510 and 520 are shown in FIG. 19, system 500 may include two or more housings, or three or more housings. System 500 includes at least some, but typically all, of the components present in monitor 18 shown in FIGS. 5 and 6, but housed in two or more housings. The components in housings 510 and 520 may communicate by means of wire or cable 530 (shown in phantom), but in one aspect, system 500 may be wireless. In one aspect, component 510 may be mounted, for example, clipped, to a shoulder or a lapel of, for example, an emergency worker, and component 520 may be mounted to a belt or backpack, for example, by means of belt loop (not shown).

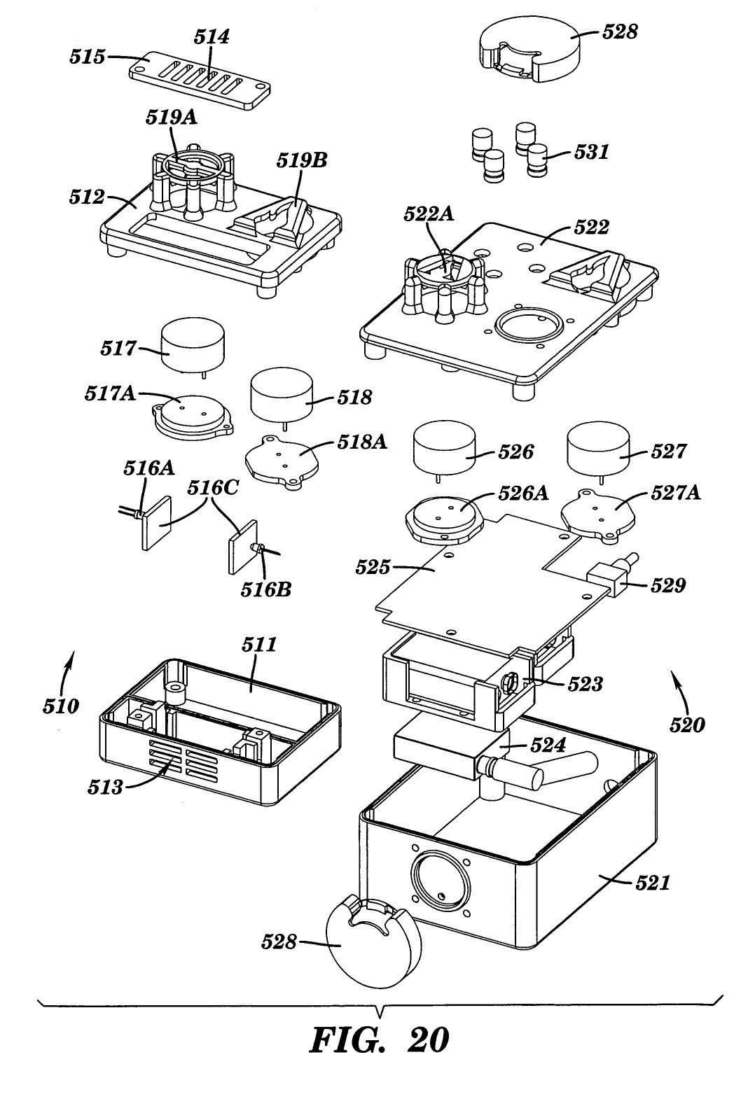

FIG. 20 is an exploded perspective view of the two-component system 500 shown in FIG. 19 having housings 510 and 520. As shown, housing 510 may comprise a base housing 511 and a removable cover 512 having openings or vents 513 and 514, for example, located in a removable cover 515. Openings or vents 513 and 514 may allow the ambient air to contact environmental sensors, reduce obstructions to the path of emitted or received signals, or allow for cooling of internal components. Base housing 511 is adapted to receive and retain components, for example, a visibility sensor having a photodiode 516A, an LED emitter 516B, and windows 516C. Base housing 511 may also be adapted to receive and retain a transmitter 517 mounted on transmitter support 517A and a receiver 518 mounted on a receiver support 518A. Cover 512 may be adapted to reduce the obstructions to the path of signals transmitted and received by transmitter 517 and receiver 518, for example, cover 12 may include structures and openings 519A and 519B. Transmitter 517 and receiver 518 may transmit and receive signals to and/or from other systems 500, or related systems and devices, or may transmit and receive signals to and/or from the components in main housing 520, for example, RF or IR signals, among others.

Similarly, housing 520 may comprise a base housing 521 and a removable cover 522 having openings or vents, such as opening 522A. Again, openings or vents in base housing 521 and cover 522 allow the ambient air to contact environmental sensors, reduce obstructions to the path of emitted or received signals, or allow for cooling of internal components. Base housing 521 is adapted to receive and retain components, for example, a battery pack or other power source 523, an RF module 524, a printed circuit board 525, a transmitter 526 mounted on a transmitter support 526A, and a receiver 527 mounted on a receiver support 527A. Base housing 521 and cover 522 may also be adapted to mount alarm housings 528, for example, an audible, a visual, or an IR alarm housing. Housing 520 may include input/output devices, for example, one or more buttons 529, for example, on/off buttons or reset buttons, and LEDs 531, for example, LEDs adapted to output a visual signal, for example, signals representative of the state of activation of the system, among other signals. Transmitter 526 and receiver 527 may transmit and receive signals to and/or from other systems 500, or related systems and devices, or may transmit and receive signals to and/or from the components in satellite housing 510, for example, RF or IR signals, among others.

Aspects of the present invention facilitate scalability. For example, since little or no information may be transmitted during the transmission and reception of signals, and since communication may be based only on a signal characteristic and the detection of a signal from other monitors, there may be unlimited numbers of members in a group practicing aspects of the invention.

In one aspect of the invention, additional functionality may be provided to a monitor. For example, in one aspect, additional functionality may include health monitoring, for example, monitoring the vital health information of the wearer of the monitor, such as respiration rate, heart rate, perspiration, and core temperature. This health data may be monitored remotely be the monitor or may be monitored by means of one or more sensors mounted to the wearer, for example, one or more electrodes mounted to the abdomen. In addition, in one aspect, one or more environment-sensing devices or ambient condition sensing devices may be incorporated into the invention, for example, that measure factors of the environment surrounding the monitor. These factors may include, but are not limited to, temperature, oxygen concentration, explosive gas concentration, the presence of smoke, particle density, visibility, and hazardous material presence, among others. The controller in the monitor may have the capability of adjusting or varying the predetermined signal characteristic value based on the environmental conditions sensed.

In one aspect of the invention, it may be possible to manage accountability of individual monitors and members of a group, for example, through the use of radio frequency technology. In addition, in one aspect, each monitor may have the capability to transmit a unique identifier, for example, a unique identifier that may be received and used by other monitors to monitor the presence or absence of group members. In another aspect, a monitor may include functionality to transmit group member information to a receiver, for example, to a receiver remote from the group. In one aspect, an individual identifier could be used to track information on a member having a monitor, such as, a member's medical information or medical history, among other information. In one aspect, identifying data stored in a monitor may correspond to a database of information on the member assigned the monitor. This information may include medical information which may be retrieved through a receiver or an interrogator integrated with a means of communication with a database.

As discussed above, aspects of the invention may provide for the transmission of monitor specific identifiers which may allow groups having monitors to add new members, subtract existing members, and to track group member accountability in real time. Additionally, in one aspect, relative positioning may be provided through triangulation of the signals transmitted from the monitors, for example, by conventional triangulation means.

Aspects of the present invention provided methods, systems, and devices that can be applied to any application where group proximity and/or integrity is desired or required. For example, aspects provide methods, systems, and devices which grouped members that are preferably located within a required distance or proximity with the capability of maintaining that proximity. Aspects of the invention also allow individuals or groups to enter or leave an existing group, for example, to form independent groups, for instance, whose membership may change over time.

In one aspect of the invention, methods, systems, and devices are provided that can enhance the survivability of emergency workers, most notably, firefighters, policemen, hazardous material handlers, rescue workers, and medical technicians, but also scuba divers, bodyguards, and the armed forces or military personnel, among others. In particular, aspects of the invention can be used by firefighters, both paid and volunteer, to enhance the survivability of firefighters who enter a burning structure as a group. One aspect of the invention is marketed under the name Team Accountability Buddy System (TABS) by TekAlert of Troy, N.Y. Where existing methods maintain integrity of the group by typically requiring continuous physical contact between firefighters, aspects of the present invention may be used to enhance survivability while not requiring physical contact. Aspects of the invention not only facilitate keeping the group in tact, but also provide effective means of locating and recovering firefighters should separation from the group occur. Aspects of the invention may also be applied to the monitoring the relative locations of one or more objects, for example, with respect to other objects or with respect to personnel. Aspects of the invention may also be applied to the monitoring of the location of children or adults in the care of others, for example, to the locating of children by a parent in a shopping mall or store, among others.

While several aspects of the present invention have been described and depicted herein, alternative aspects may be envisioned by those skilled in the art to accomplish the same objectives. Accordingly, it is intended by the appended claims to cover all such alternative aspects as fall within the true spirit and scope of the invention.

1. A method for monitoring the distance of between members of a group, the method comprising:
providing each of the members with a monitor, the monitor adapted to transmit at least one signal, to receive at least one signal transmitted from at least one other monitor, and to determine a characteristic of the at least one received signal representative of the distance of the monitor from the at least one other monitor within the group;
transmitting at least one first signal from a first monitor provided to a first member of the group;
receiving the at least one first signal by a second monitor provided to a second member of the group;
determining the characteristic of the at least one received first signal representative of the distance between the first monitor and the second monitor;
comparing the characteristic of the at least one received first signal to a predetermined characteristic; and
when the determined characteristic deviates from the predetermined characteristic, activating a signal advising at least one member of the deviation.

2. The method as recited in claim 1, wherein the members comprise at least three members.

3. The method as recited in claim 1, wherein the characteristic of the received signal representative of the distance between the first monitor and the second monitor comprises one of signal strength, signal time of arrival, signal phase, signal shape, and information related to the position of the first monitor.

4. The method as recited in claim 1, wherein transmitting the at least one first signal comprises transmitting at least one first signal and at least one second signal.

5. The method as recited in claim 4, wherein receiving the at least one first signal comprises receiving the at least one first signal and the at least one second signal.

6. The method as recited in claim 5, wherein determining the characteristic of the at least one received first signal representative of the distance between the first monitor and the second monitor comprises determining the difference in the time of arrival between the at least one first signal and the at least one second signal.

7. The method as recited in claim 6, wherein the at least one first signal comprises a radio frequency signal and the at least one second signal comprises an ultrasonic signal.

8. The method as recited in claim 1, further comprising:
creating a first group and a second group, the first group and second group each comprising a sub-group of the group, the first group and the second group having at least one member; and
recognizing the first group and the second group as distinct groups;
wherein recognizing the first group and the second group as distinct groups comprises having the monitors of the members of the first group not activate a signal when the characteristic of the at least one signal from a monitor of a member of the second group deviates from the predetermined characteristic.

9. The method as recited in claim 1, wherein the method further comprises:
accepting at least one new member to the group from outside the group, the at least one new member having a monitor;
wherein accepting at least one new member comprises having the monitor of the at least one new member activate a signal when the characteristic of at least one signal from at least one of the monitors of the group received by the monitor of the at least one new member deviates from the predetermined characteristic.

10. The method as recited in claim 1, wherein the members comprise one or more of humans, animals, and objects.

11. The method as recited in claim 1, wherein activating a signal comprises activating an alarm signal.

12. The method as recited in claim 11, wherein activating an alarm signal comprises activating one of an audible alarm signal, a visual alarm signal, an electromagnetic radiation alarm, and a palpable alarm signal.

13. The method as recited in claim 1, wherein transmitting and receiving comprise wireless transmitting and wireless receiving.

14. The method as recited in claim 1, further comprising detecting an environmental condition and varying the predetermined characteristic in response to the environmental condition.

15. The method as recited in claim 1, wherein activating a signal comprises activating a first alarm signal for a first duration and activating a second alarm signal, different from the first alarm signal, for a second duration.

16. A device for use in monitoring the distance between members of a group, the device comprising:
a transmitter adapted to transmit at least one signal;
a receiver adapted to receive at least one signal transmitted from at least one other device;
means for determining a characteristic of the at least one received signal representative of the distance to the at least one other device;
means for comparing the characteristic of the at least one received signal to a predetermined characteristic; and
means for activating a signal when the characteristic deviates from the predetermined characteristic.

17. The device as recited in claim 16, wherein the characteristic of the received signal representative of the distance to the at least one other device comprises signal strength.

18. The device as recited in claim 16, wherein the transmitter adapted to transmit at least one signal comprises a transmitter adapted to transmit at least one first signal and at least one second signal.

19. The device as recited in claim 18, wherein the receiver adapted to receive at least one first signal comprises a receiver adapted to receive at least one first signal and at least one second signal.

20. The device as recited in claim 19, wherein the means for determining the characteristic of the at least one received first signal representative of the distance to the at least one other device comprises means for determining the difference in the time of arrival between the at least one first signal and the at least one second signal.

21. The device as recited in claim 20, wherein the at least one first signal comprises a radio frequency signal and the at least one second signal comprises an ultrasonic signal.

22. A method for improving the survivability of emergency workers working in a group in proximity to each other, the method comprising:
providing each emergency worker with a monitor, the monitor adapted to transmit at least one signal, to receive at least one signal transmitted from at least one other monitor, and to determine a characteristic of the at least one received signal representative of the distance of the monitor from the at least one other monitor within the group;
transmitting at least one first signal from a first monitor provided to a first emergency worker;
receiving the at least one first signal by a second monitor provided to a second emergency worker;
determining the characteristic of the at least one received first signal representative of the distance between the first monitor and the second monitor;
comparing the characteristic of the at least one received first signal to a predetermined characteristic; and
when the characteristic deviates from the predetermined characteristic, activating a signal advising at least one emergency worker in the group of the deviation.

23. The method as recited in claim 22, wherein the characteristic of the received signal representative of the distance between the first monitor and the second monitor comprises signal strength.

24. The method as recited in claim 22, wherein transmitting the at least one first signal comprises transmitting a radio frequency signal and an ultrasonic signal.

25. The method as recited in claim 24, wherein receiving the at least one first signal comprises receiving the radio frequency signal and the ultrasonic signal.

26. The method as recited in claim 25, wherein determining the characteristic of the at least one received first signal representative of the distance between the first monitor and the second monitor comprises determining the difference in the time of arrival between the radio frequency signal and the ultrasonic signal.

27. The method as recited in claim 22, further comprising:
creating a first group of emergency workers and a second group of emergency workers, the first group and second group each comprising a sub-group of the group of emergency workers, the first group and the second group having at least one emergency worker; and
recognizing the first group and the second group as distinct groups;
wherein recognizing the first group and the second group as distinct groups comprises having the monitors of the emergency workers of the first group not activate a signal when the characteristic of the at least one signal from a monitor of an emergency worker of the second group deviates from the predetermined characteristic.

28. The method as recited in claim 22, wherein the method further comprises:
accepting at least one new emergency worker to the group of emergency workers from outside the group, the at least one new emergency worker having a monitor;
wherein accepting at least one new emergency worker comprises having the monitor of the at least one new emergency worker activate a signal when the characteristic of at least one signal from at least one of the monitors of the group of emergency workers received by the monitor of the at least one new emergency worker deviates from the predetermined characteristic.

29. The method as recited in claim 22, wherein the emergency workers comprise one of firefighters, policemen, rescue workers, medical technicians, SCUBA divers, bodyguards, and military personnel.

30. The method as recited in claim 22, wherein activating a signal comprises activating one of an audible alarm signal, a visual alarm signal, and a palpable alarm signal.

31. The device as recited in claim 16, further comprising at least one ambient condition sensor.

32. The device as recited in claim 31, wherein the ambient condition sensor comprises at least one of a visibility sensor, a temperature sensor, and a gas sensor.

33. The device as recited in claim 31, further comprising means for varying the predetermined characteristic as a function of the ambient condition.

34. A method for monitoring the distance between members of a group, the method comprising:
providing each of the members with a monitor, the monitor adapted to determine the position of the monitor, adapted to transmit at least one signal containing information related to the position of the monitor, and adapted to receive at least one signal transmitted from at least one other monitor;
determining the position of the first monitor;
transmitting at least one first signal from a first monitor provided to a first member of the group, the first signal containing information related to the position of the first monitor;
receiving the at least one first signal containing information related to the position of the first monitor by a second monitor provided to a second member of the group;
determining the position of the second monitor;
comparing the position of the first monitor to the position of the second monitor to determine a distance between the first monitor and the second monitor;
comparing the distance to a predetermined distance; and
when the distance deviates from the predetermined distance, activating a signal advising at least one member of the deviation.

35. The method as recited in claim 34, wherein the deviation is one of larger than the predetermined distance and smaller than the predetermined distance.

36. The methods as recited in claim 35, wherein determining the position of the first monitor is practiced using one of an accelerometer and a global positioning system.

37. A device for monitoring the distance between members of a group, the device comprising:
means for determining the position of the device;
a transmitter adapted to transmit at least one signal, the at least one signal containing information related to the position of the device;
a receiver adapted to receive at least one signal transmitted from at least one other device, the received signal containing information related to the position of the other device;
means for comparing the position of the device to the position of the other device to determining a distance between the device and the other device;
means for comparing the distance to a predetermined distance; and
means for activating a signal when the distance deviates from the predetermined distance.

38. The method as recited in claim 37, wherein the means for activating a signal when the distance deviates from the predetermined distance comprises means for activating a signal when the distance is one of larger and smaller than the predetermined distance.

39. The methods as recited in claim 37, wherein the means for determining the position of the device comprises one of an accelerometer and a global positioning system.

40. A method for monitoring a distance between members of a group, the method comprising:
providing each of the members with a monitor, the monitor adapted to determine the relative position of each monitor and the other monitors;
determining the distance between the monitors;
comparing the distance to the distance to the predetermined distance; and
activating a signal when the distance between at least two monitors deviates from the predetermined distance.

41. The method as recited in claim 40, wherein the predetermined distance comprises one of a maximum distance and a minimum distance.

42. The method as recited in claim 41, wherein the determining the distance between monitors is practiced using methods comprising one of electromagnetic signal characteristic detection, accelerometers, and radio wave positioning.

43. A device for monitoring the distance between members of a group, the device comprising:
means for determining the distance from the device to another similar device; and
means for activating a signal when the distance between the devices deviates from a predetermined distance.

44. The device as recited in claim 43, wherein the predetermined distance comprises one of a maximum distance and a minimum distance.

45. The device as recited in claim 43, wherein the means for determining the distance from the device and another similar device comprises one of electromagnetic signal characteristic detection, accelerometers, and radio wave positioning.
